(19) United States
(12) Patent Application Publication
(10) Pub. No.: US 2020/0165153 A1
(43) Pub. Date: May 28, 2020

(54) MOLD AND METHOD FOR PRODUCING BARBED GLASS PLATE

(71) Applicant: AAC Acoustic Technologies (Shenzhen) Co., Ltd., Shenzhen (CN)

(72) Inventors: Qishan Dan, Shenzhen (CN); Xudong Yan, Shenzhen (CN)

(21) Appl. No.: 16/695,106

(22) Filed: Nov. 25, 2019

(30) Foreign Application Priority Data
Nov. 27, 2018 (CN) 201811422460.8

(51) Int. Cl. C03B 23/03

(52) U.S. Cl. CPC C03B 23/0302; C03B 2215/50; C03B 2215/40

(57) ABSTRACT

A mold for producing a barbed glass plate and a method for producing the barbed glass plate are disclosed. The barbed glass plate includes a body portion, a transition portion, and an extension portion. The body portion, the transition portion, and the extension portion cooperatively define a receiving space. The extension portion includes an external surface facing away from the receiving space. The mold includes a lower die and an upper die. The lower die includes a bottom wall and a side wall. The upper die includes a protrusion. When the upper die is engaged with the lower die, the protrusion protrudes into the cavity and is spaced apart from the side wall.

### CROSS REFERENCE TO RELATED APPLICATIONS

This application claims priority to Chinese Patent Application No. 201811422460.8, filed on Nov. 27, 2018, the contents of which are herein incorporated by reference in their entireties.

### TECHNICAL FIELD

The present disclosure relates to the technical field of glass forming, and in particular, to a mold for producing a barbed glass plate and a method for producing the barbed glass plate.

### BACKGROUND

With the development of the Internet era, electronic devices (such as mobile phones, tablets, notebooks, and the like) have been increasingly popular with people. In addition to the functional requirements, users have higher and higher requirements for the appearance of the electronic devices, and more and more housings of the electronic devices use three-dimensional glass products.

However, in the related art, molds for processing glass substrates may achieve only the bending at an angle less than or equal to 90° at edges and corners of the glass substrates.

### BRIEF DESCRIPTION OF THE DRAWINGS

In order to describe the technical solutions in embodiments of the present disclosure more clearly, the following briefly introduces the accompanying drawings required for describing the embodiments. Apparently, the accompanying drawings in the following description are merely some embodiments of the present disclosure. For those skilled in the art, other drawings can be obtained based on these drawings without creative efforts.

FIG. 1 is a cross-sectional view of a mold for processing a three-dimensional glass substrate according to some embodiments of the present disclosure, wherein the mold is in a mold-opening state.

FIG. 2 is a cross-sectional view of the mold for processing the three-dimensional glass substrate according to some embodiments of the present disclosure, wherein the mold is in a mold-closing state.

FIG. 3 is a cross-sectional view showing one operation state of the mold shown in FIG. 1 and the glass substrate according to some embodiments of the present disclosure.

FIG. 4 is a cross-sectional view showing another operation state of the mold shown in FIG. 1 and the glass substrate according to some embodiments of the present disclosure.

FIG. 5 is a schematic view of a product produced by the planar glass by using the mold as shown in FIG. 1.

FIG. 6 is a schematic structural view of a barbed glass plate according to some embodiments of the present disclosure.

FIG. 7 is a perspective view of a mold for producing the barbed glass plate according to some embodiments of the present disclosure.

FIG. 8 is an exploded view of the mold for producing the barbed glass plate according to some embodiments of the present disclosure.

FIG. 9 is a cross-sectional view of the mold for producing barbed glass plate according to some embodiments of the present disclosure, wherein the mold is in a mold-opening state.

FIG. 10 is a cross-sectional view of the mold for producing barbed glass plate according to some embodiments of the present disclosure, wherein the mold is in a mold-closing state.

FIG. 11 is a flow chart of a method for producing a barbed glass plate according to some embodiments of the present disclosure.

FIG. 12 is a schematic view showing a state of the block S2 of the method shown in FIG. 11 according to some embodiments of the present disclosure.

FIG. 13 is a schematic view showing a state of the block S3 of the method shown in FIG. 11 according to some embodiments of the present disclosure.

FIG. 14 is a schematic view showing a state of the block S5 of the method shown in FIG. 11 according to some embodiments of the present disclosure.

### DETAILED DESCRIPTION

The technical solutions in the embodiments of the present disclosure will be clearly and completely described in detail below with reference to the accompanying drawings in the embodiments of the present disclosure. Apparently, the embodiments described herein are only some exemplary embodiments, not all the embodiments. Based on the embodiments described in the present disclosure, one skilled in the art may acquire all other embodiments without any creative efforts. All these shall be covered within the protection scope of the present disclosure.

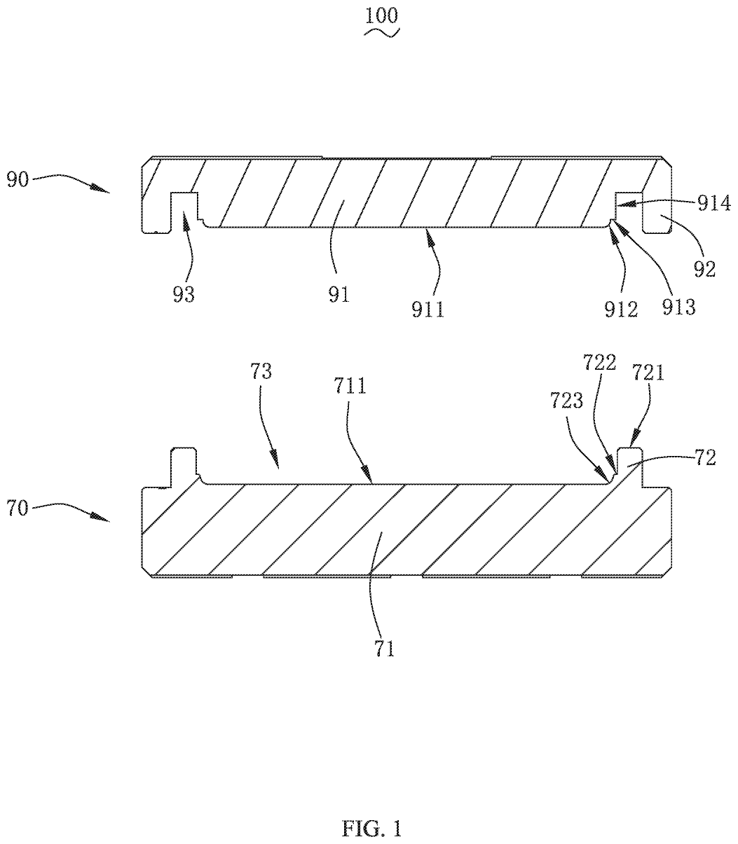

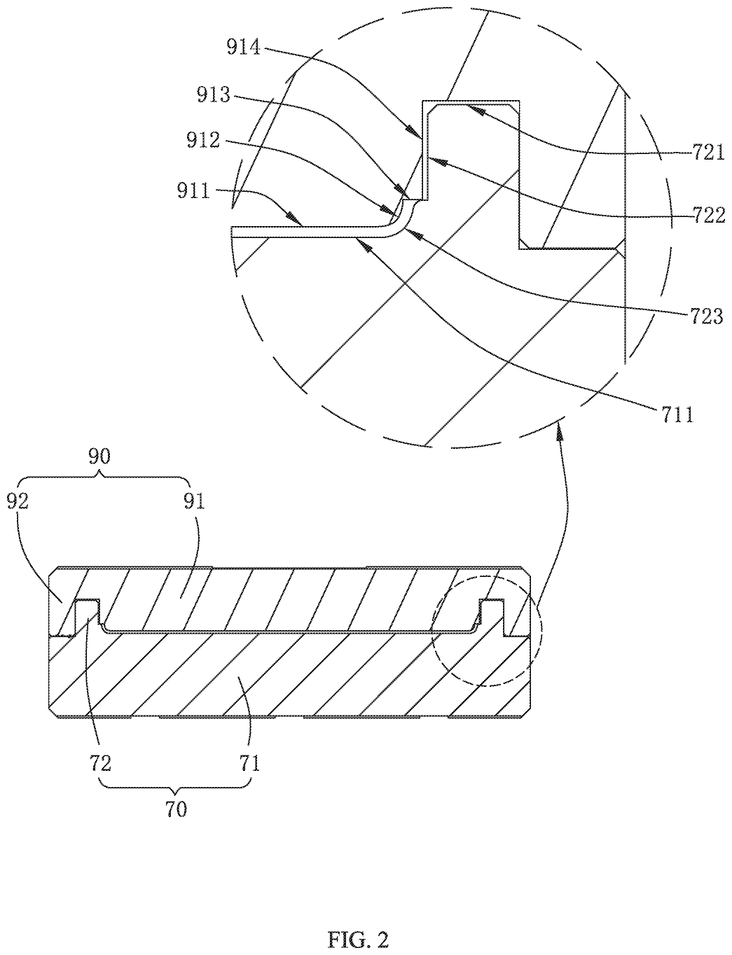

FIGS. 1-2 are cross-sectional views of a mold for processing a three-dimensional glass substrate according to some embodiments of the present disclosure. The mold 100 may be used for bending a planar glass into a glass substrate having a three-dimensional glass structure. As shown in FIGS. 1-2, the mold 100 may include a first die 70 and a second die 90. The first die 70 may be a female die and may define a receiving cavity 73. The second die 90 may cooperate with the first die 70. The second die 90 may be a male die having a punch cooperating with the receiving cavity 73 of the first die 70. More specifically, the mold 100 may have a mold-closing state in which the first die 70 may be engaged/clamped with the second die 90 to define a molding space for molding or manufacturing the three-dimensional glass structure, and may have a mold-opening state in which the first die 70 may be disengaged/separated from the second die 90.

Hereafter, the term “horizontal direction” may refer to a direction substantially perpendicular to a mold-closing or mold-opening direction of the mold 100. The term “vertical direction” may refer to a direction substantially parallel to a mold-closing or mold-opening direction of the mold 100.

In some embodiments, the first die 70 may include a base 71 and a side arm 72. The side arm 72 may cooperate with the base 71 to enclose/define the receiving cavity 73. The second die 90 may include a protrusion 91. When the mold 100 is in the mold-closing state, the protrusion 91 may protrude into the receiving cavity 73, and be spaced apart from the side arm 72. The protrusion 91 may cooperate with the base 71 and the side arm 72 to define the molding space for molding or manufacturing the three-dimensional glass structure.

More specifically, in some embodiments, the base 71 may include a first inner surface 711 located at a bottom of the receiving cavity 73. The side arm 72 may include an upper surface 721, a second inner surface 722, and a shaping surface 723. The second inner surface 722 may be connected to the upper surface 721 and may face towards the receiving cavity 73. The shaping surface 723 may be connected to the second inner surface 722 and the first inner surface 711. The first inner surface 711, the second inner surface 722, and the shaping surface 723 may cooperatively define the receiving cavity 73. In some embodiments, the shaping surface 723 may be a curved surface, and may be in shaped of an arc.

The protrusion 91 may include a first lower surface 911, a first outer side surface 912, a second lower surface 913, and a second outer side surface 914. The first lower surface 911 may oppositely face towards the first inner surface 711. The first outer side surface 912 may extend from the first lower surface 911 in a direction away from (opposite to) the base 71. The second lower surface 913 may extend along the horizontal direction from the first outer side surface 912. The second outer side surface 914 may extend along the vertical direction from the second lower surface 913 in a direction away from the base 71. The second outer side surface 914 may be opposite to the second inner surface 722 of the side arm 72.

When the mold 100 is in the mold-closing state, the second lower surface 913 of the protrusion 91 may partially abut against the shaping surface 723 of the side arm 72. In this case, the first inner surface 711, the shaping surface 723, the first lower surface 911, the first outer side surface 912, and the second lower surface 913 may cooperatively define the molding space. A distance between the first inner surface 711 and the first lower surface 911 and a distance between the first outer side surface 912 and the shaping surface 723 may be substantially equal to a thickness of the planar glass.

In some embodiments, the first inner surface 711 may be substantially perpendicular to the second inner surface 722 and the second outer side surface 914, and substantially parallel to the first lower surface 911. In some embodiments, the first inner surface 711 and the first lower surface 911 may be both horizontal surfaces (that is, the surfaces extend in the horizontal direction). The second inner surface 722 and the second outer side surface 914 may be vertical surfaces (that is, the surfaces extend in the vertical direction).

In some embodiments, the second die 90 may further include a baffle 92. The baffle 92 may be disposed on an outer periphery of the protrusion 91 and spaced apart from the protrusion 91 to define a recess 93. When the mold 100 is in the mold-closing state, the side arm 72 of the first die 70 may be engaged in the recess 93. In some embodiments, the side arm 72 may be disposed adjacent to an edge of the base 71. In this case, when the second die 90 is engaged with the first die 70, the edge of the base 71 may support the baffle 92.

In some embodiments, the second die 90 may have a thermal expansion coefficient greater than that of the glass, and the first die 70 may have a thermal expansion coefficient less than that of the glass. During the cooling of the three-dimensional glass product, the second die 90 may have a shrinkage speed greater than that of the glass, and the first die 70 may have a shrinkage speed less than that of glass. In this way, the three-dimensional glass product may be easy to take out, and the yield may be improved.

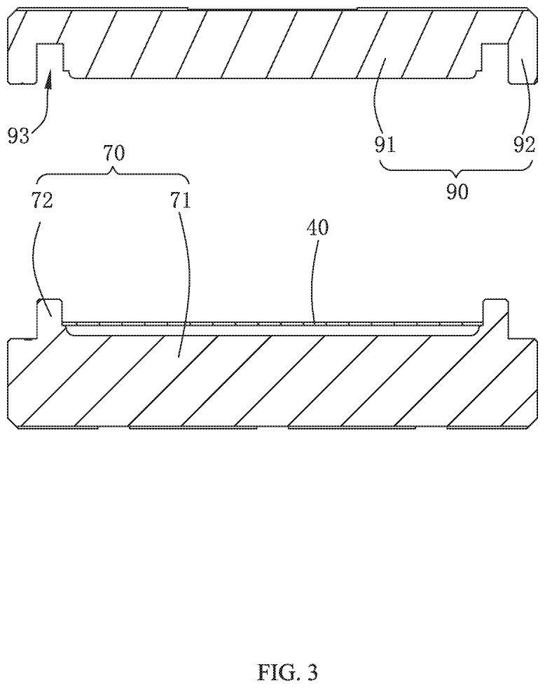

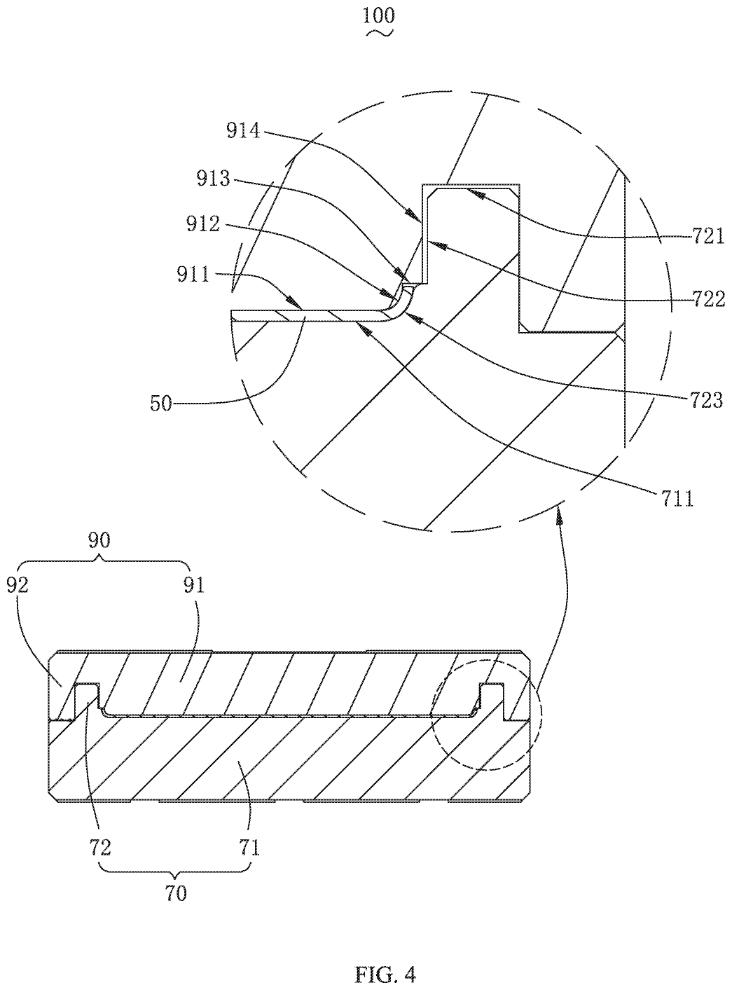

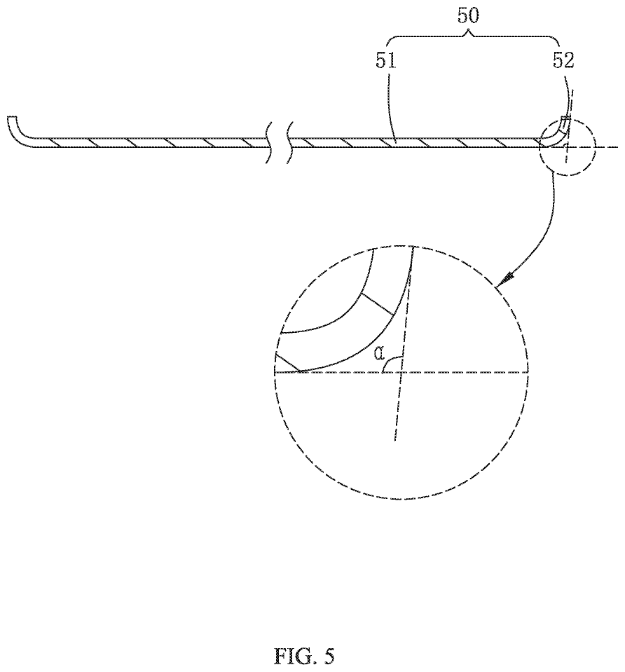

As shown in FIGS. 3-5, during the processing, a planar glass 40 may be provided. The planar glass 40 may be fixed to the first die 70, and then the second die 90 may be engaged or clamped with the first die 70, such that the planar glass 40 may be formed into a glass substrate 50 having a structure as shown in FIG. 5. As shown in FIG. 5, the glass substrate 50 may include a substrate body 51 and a bending portion 52 bent from the substrate body 51. In some embodiments, the substrate body 51 may have a flat shape. An angle between the bending portion 52 and the substrate body 51 may be ranged from approximately 90° to approximately 100°. In some embodiments, the angle may be an angle defined between a tangent of an end of the bending portion and a horizontal plane (that is, the plane perpendicular to the vertical direction), and angle may further face towards the inner side of the substrate 50, as shown in the angle α in FIG. 5.

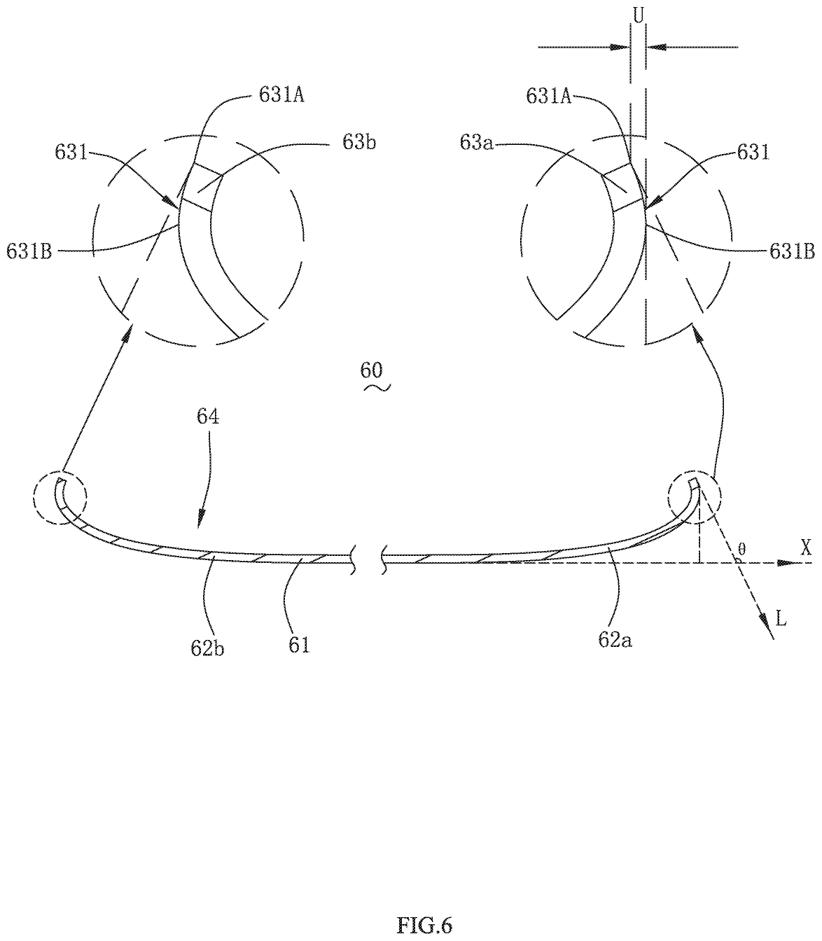

In some embodiments of the present disclosure, a mold 200 for producing a barbed glass plate may be further provided. The mold 200 may be used for processing the glass substrate 50 having a three-dimensional glass structure to produce a barbed glass plate 60. As shown in FIG. 6, the barbed glass plate 60 may include a body portion 61, a transition portion 62, and an extension portion 63. The transition portion 62 may be bent from an edge of the body portion 61. The extension portion 63 may be bent from an edge of the transition portion 62. The body portion 61 may cooperate with the transition portion 62 and the extension portion 63, to cooperatively define or enclose a receiving space 64 opened at one end. The extension portion 63 may include a external surface 631 facing away from the receiving space 64. The external surface 631 may include an end point 631A and a connection point 631B. The end point 631A may face away from the body portion 61. The connection point 631B may be connected to the transition portion 62. A tangential direction of the external surface 631 at the connection point 631B may be substantially perpendicular to the horizontal direction. An angle between a tangential direction of the external surface 631 at the end point 631A and the horizontal direction and facing away from the receiving space 64 may be set as θ, wherein θ may satisfy: 90°<θ≤180°. In some embodiments, θ may satisfy: 110°≤θ≤180°. A distance between the connection point 631B and the end point 631A in the horizontal direction may be set as U, and U may be ranged from approximately 0.15 mm to approximately 1 mm. The barbed glass plate 60 may have a barb. A size at the opening of the receiving space 64 may be less than a size in the interior of the receiving space 64.

In some embodiments, as shown in FIG. 6, the barbed glass plate 60 may have two extension portions 63 (i.e., the first extension portion 63a and the second extension portion 63b) and two transition portions 62 (i.e., the first transition portion 62a and the second transition portion 62b). The first transition portion 62a may be bent from a first end of the body portion 61, and the second transition portion 62b may be bent from a second end (opposite to the first end) of the body portion 61. The first extension portion 63a may be bent from the first transition portion 62a. The second extension portion 63b may be bent from the second transition portion 63b. The extension portions 63a and 63b are disposed at one end of the glass plate 60 at which the opening is defined.

The first extension portion 63a may include a first external surface 631 facing away from the receiving space 64. The first external surface 631 may include a first end point 631A and a first connection point 631B. The first end point 631A may face away from the body portion 61, and the first connection point 632B may be connected to the first transition portion 62.

wherein the second extension portion 63b may include a second external surface 631 facing away from the receiving space 64. The second external surface 631 may include a second end point 631A and a second connection point 631B. The second end point 631A may face away from the body portion 61, and the second connection point 631B may be connected to the second transition portion 62.

A distance between the first end point and the second end point is less than a distance from between the first connection point and the second connection point. In this way, the glass plate 60 may have a more aesthetical appearance, the feel of grip may be better, and the glass plate 60 may be convenient to assemble.

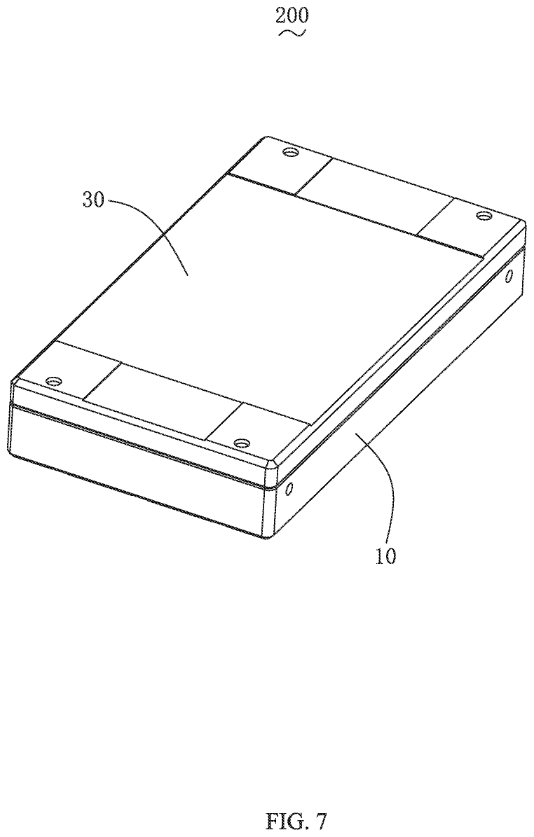

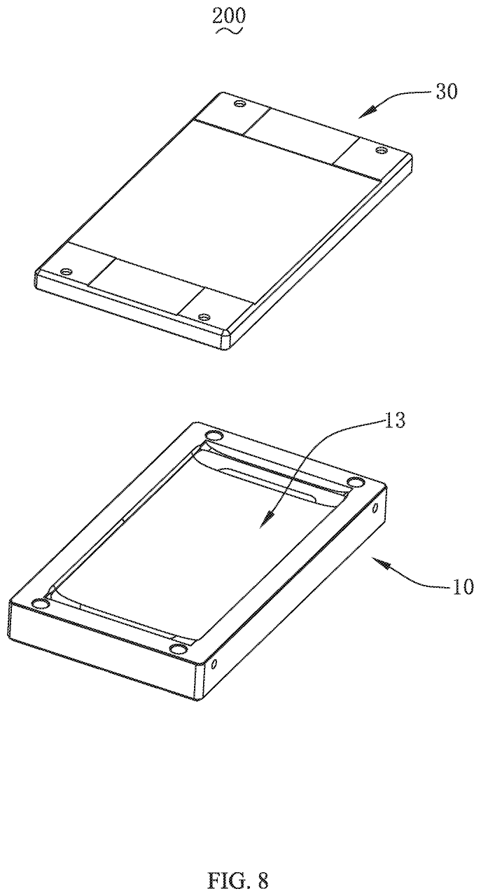

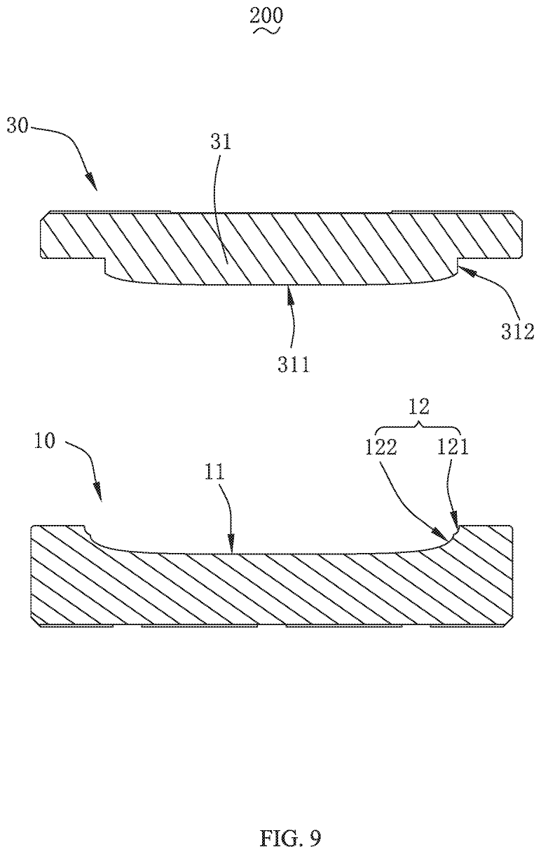

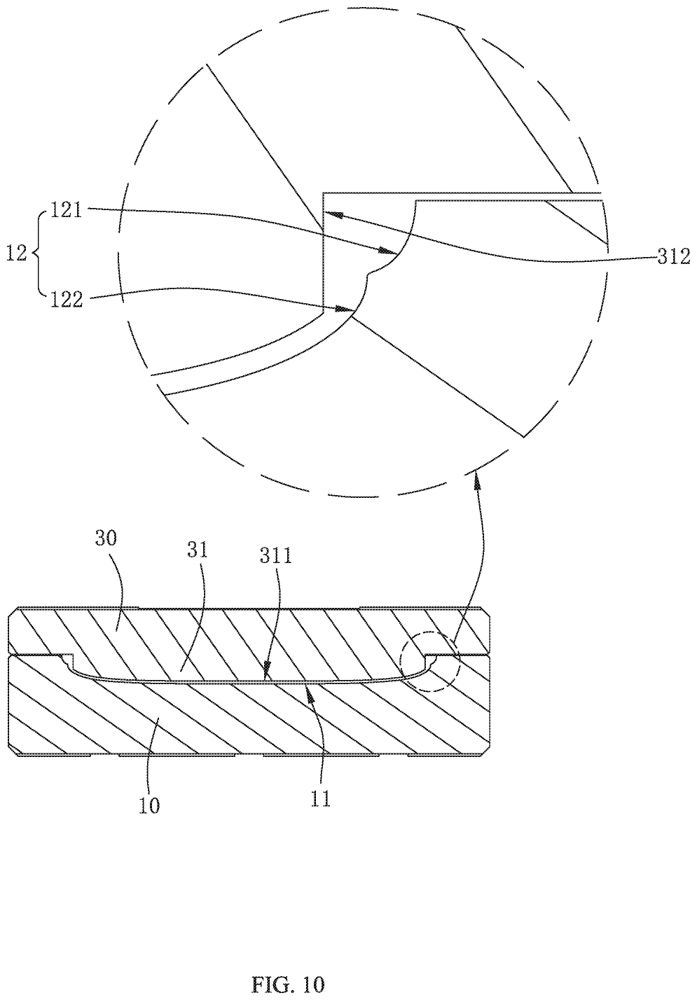

As shown in FIGS. 7-10, the mold 200 may include a lower die 10 and an upper die 30. The lower die 10 may define a cavity 13. The upper die 30 may cooperate with the lower die 10. More specifically, the mold 200 may have a mold-closing state in which the upper die 30 may be engaged/clamped with the lower die 10 to define a molding space for molding or manufacturing the three-dimensional glass structure, and may have a mold-opening state in which the upper die 30 may be disengaged/separated from the lower die 10.

The lower die 10 may include a bottom wall 11 and a side wall 12. The side wall 12 may cooperate with the bottom wall 11 to enclose/define the cavity 13. The side wall 12 may be connected and transitioned to the bottom wall 11 via an arc. The upper die 30 may include a protrusion 31. When the mold 200 is in the mold-closing state, the protrusion 31 may protrude into the receiving cavity 13, and be spaced apart from the side wall 12. Besides, a distance between the protrusion 31 and the side wall 12 may be greater than or equal to a sum of a thickness of the extension portion 63 and the distance U, and may be further less than or equal to twice the sum of the thickness of the extension portion 63 and the distance U.

An overall shape of the glass substrate 50 may be the same as or similar to a shape of the cavity 13. Since the distance between the protrusion 31 and the side wall 12 may be greater than or equal to a sum of a thickness of the extension portion 63 and the distance U and less than or equal to twice the sum of the thickness of the extension portion 63 and the distance U, when the mold 200 is in the mold-closing state, the protrusion 31 may gradually protrude into the cavity 13, during which the protrusion 31 may press the substrate body 51. Under the action of the side wall 12 of the lower die 10, the bending portion 52 may be formed into the transition portion 62 and the extension portion 63 bent from the edge of the transition portion 62 of the barbed glass plate 60 by means of thermal pressing.

In some embodiments, the side wall 12 may include a receiving surface 121 and a connecting surface 122. The receiving surface 121 may be configured to provide a clearance to and receive the bending portion 52. The connecting surface 122 may be connected to the receiving surface 121 and the bottom wall 11. The protrusion 31 may include a top surface 311 and a side surface 312. The top surface 311 may oppositely face towards the bottom wall 11. The side surface 312 may extend from the top surface 311 in a direction away from (opposite to) the bottom wall 11. When the mold 200 is in the mold-closing state, a distance between the side surface 312 and the receiving surface 121 may be greater than a distance between the side surface 312 and the connecting surface 122. Besides, the distance between the side surface 312 and the connecting surface 122 may be greater than the sum of the thickness of the extension portion 63 and the distance U, and less than or equal to twice the sum of the thickness of the extension portion 63 and the distance U. By using the difference between the size of the protrusion 31 of the upper die 30 and that of the side wall 12 of the lower die 10, one end of the bending portion 52 that is away from/opposite to the substrate body 51 may be bent in a direction towards the receiving space, such that the barb may be formed.

In some embodiments, the bottom wall 11 may be a flat surface. The receiving surface 121 and the connecting surface 122 may be both curved surfaces, or may be in shape of arcs. The side surface 312 may be a vertical surface. A shape of the top surface 311 may match with a shape of the bottom wall 11.

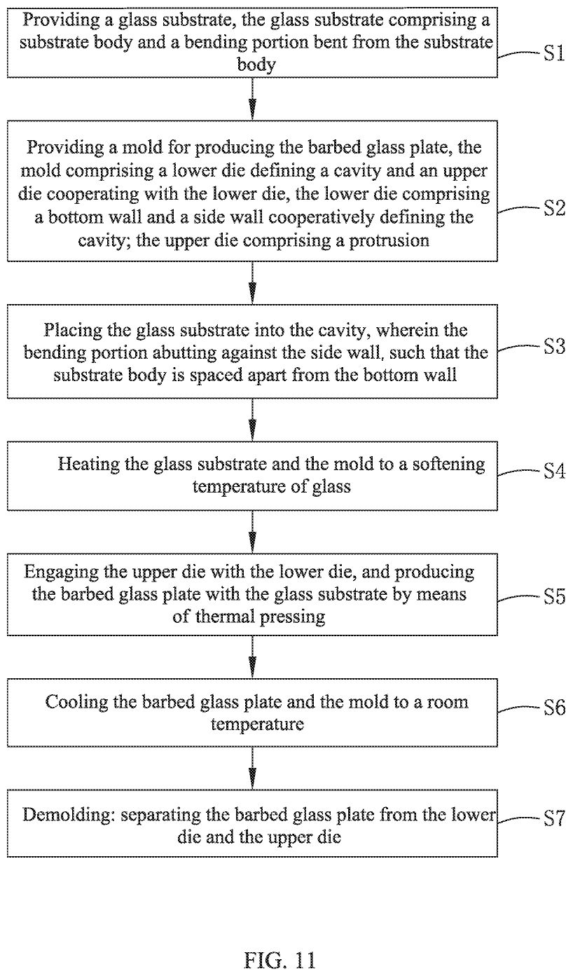

In some embodiments of the present disclosure, a method for producing a barbed glass plate may also be provided. As shown in FIG. 11, the method may include operations executed by the following blocks.

At block S1, a glass substrate 50 may be provided. The glass substrate 50 may include a substrate body 51 and a bending portion 52 bent from the substrate body 51.

At this block, the glass substrate 50 may be manufactured or processed by using a method for processing the glass substrate 50. The method for producing the glass substrate 50 may include operations executed by the following blocks.

At block S11, a planar glass 40 may be provided.

At block S12, a mold 100 may be provided. The mold 100 may be the mold 100 described above.

As described above, the mold 100 may include a first die 70 and a second die 90. The first die 70 may define a receiving cavity 73. The second die 90 may include a protrusion 91 that cooperates with the receiving cavity 73. A distance between a surface forming the receiving cavity and a surface on which the protrusion 91 is arranged may be substantially equal to a thickness of the planar glass 40. In some embodiments, the second die 90 may have a thermal expansion coefficient greater than that of the glass, and the first die 70 may have a thermal expansion coefficient less than that of the glass.

At block S13, the planar glass 40 may be fixed to the first die 70. The second die 90 may be engaged with the first die 70, such that the glass substrate 50 including the substrate body 51 and the bending portion 52 may be produced by the planar glass 40.

At block S2, a mold 200 for producing a barbed glass plate may be provided.

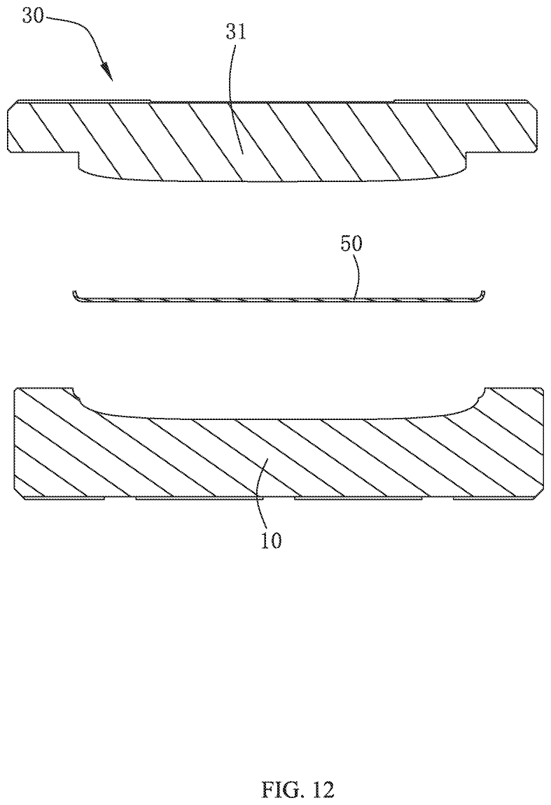

As shown in FIG. 12, the mold 200 may include a lower die 10 and an upper die 30. The lower die 10 may define a cavity 13. The upper die 30 may cooperate with the lower die 10. The lower die 10 may include a bottom wall 11 and a side wall 12. The bottom wall 11 and the side wall 12 may cooperatively define the cavity 13. The upper die 30 may include a protrusion 31. Other components may be omitted.

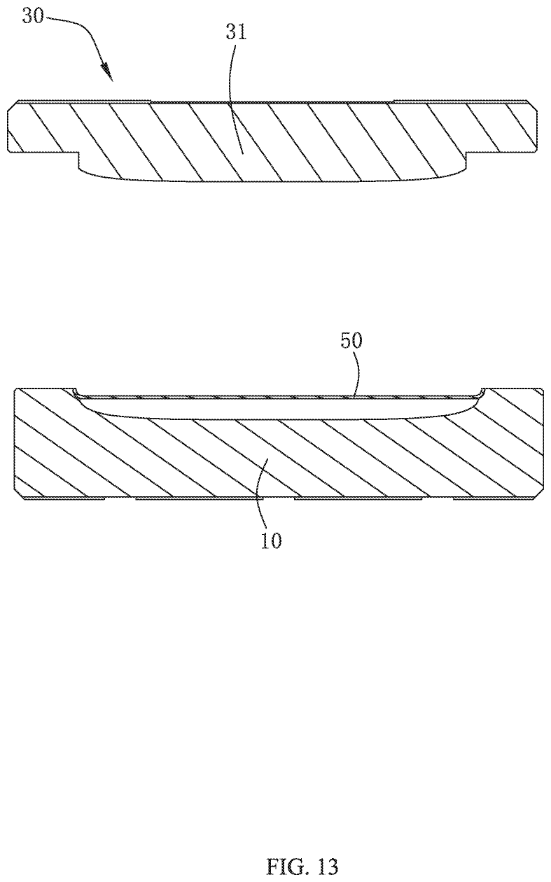

At block S3, the glass substrate 50 may be placed in the cavity 13, and the bending portion 52 of the glass substrate 50 may abut against the side wall 12, such that the substrate body 51 of the glass substrate 50 may be spaced apart from the bottom wall 11, as shown in FIG. 13.

At block S4, the glass substrate 50 and the mold 200 may be heated to a softening temperature of glass.

In some embodiments, the softening temperature of the glass may be ranged from 500° C. to 800° C. In some embodiments, the softening temperature may be approximately 700° C. In this embodiment, the softening temperature of 700° C.; after the glass substrate 50 and the mold 200 reach to the softening temperature, the temperature of the glass substrate 50 and the mold 200 may be kept at 700° C. for 3 minutes. At this block, during the heating, the mold 200 may be in the mold-opening state, and the upper die 30 may have not yet protruded into the cavity 13 of the lower die 10, which provides a preparation for the subsequent mold-closing process.

At block S5, the upper die 30 may be clamped or engaged with the lower die 10, such that the barbed glass plate 60 may be produced with the glass substrate 50 by means of thermal pressing.

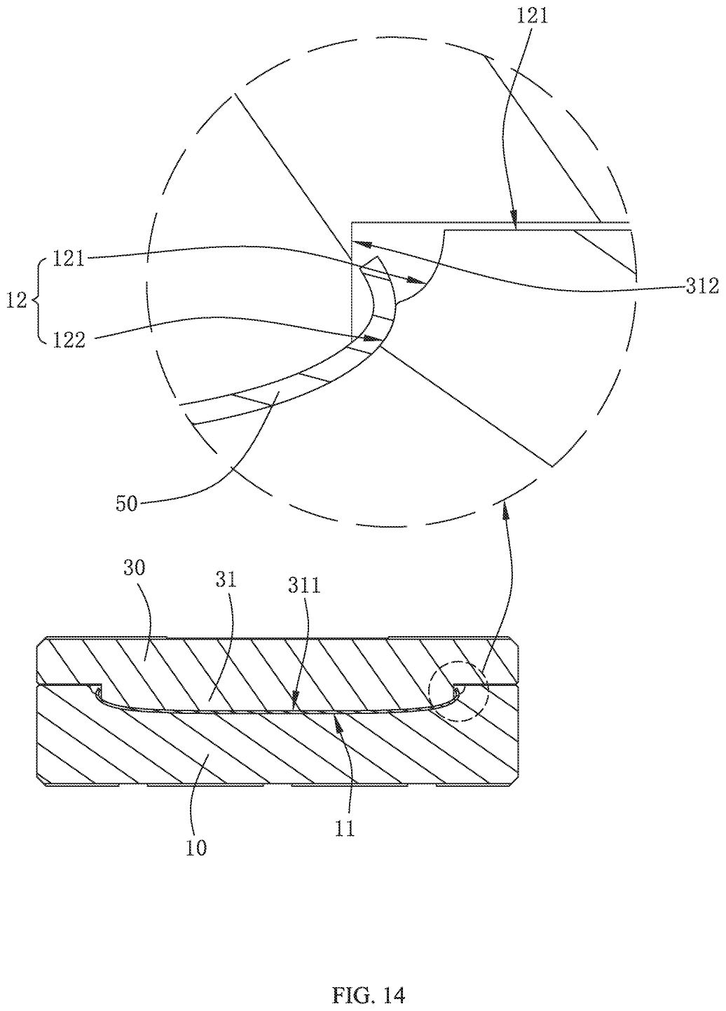

As shown in FIG. 14, when the upper die 30 is clamped or engaged with the lower die 10, the protrusion 31 may abut against the substrate body 51 of the glass substrate 50, until the substrate body 51 may be attached to the bottom wall 11 of the lower die 10. In this way, a body portion 61 of the barbed glass plate 60 may be formed. Under the action of the side wall 12 of the lower die 10, the bending portion 52 may be formed into the transition portion 62 and the extension portion 63 bent from the edge of the transition portion 62 of the barbed glass plate 60 by means of the thermal pressing. The body portion 61 may cooperate with the transition portion 62 and the extension portion 63, to cooperatively define or enclose a receiving space 64 opened at one end.

In some embodiments, the extension portion 63 may include a external surface 631 facing away from the receiving space 64. The external surface 631 may include an end point 631A and a connection point 631B. The end point 631A may face away from the body portion 61. The connection point 631B may be connected to the transition portion 62. A tangential direction of the external surface 631 at the connection point 631B may be substantially perpendicular to the horizontal direction. An angle between a tangential direction of the external surface 631 at the end point 631A and the horizontal direction and facing away from the receiving space 64 may be set as θ, wherein θ may satisfy: 90°<θ≤180°. In some embodiments, θ may satisfy: 110°≤θ—<180°. A distance between the connection point 631B and the end point 631A in the horizontal direction may be set as U, and U may be ranged from approximately 0.15 mm to approximately 1 mm.

At block S6, cooling: the barbed glass plate 60 and the mold 200 may be cooled to a room temperature.

During the cooling process, the barbed glass plate 60 may be automatically separated from the upper die 30 and the lower die 10.

At block S7, demolding: the barbed glass plate 60 may be separated from the lower die 10 and the upper die 30 to complete demolding.

After the demolding, the structure of the barbed glass plate 60 may be as shown in FIG. 6, and the specific structure will not be described again.

Compared with the related art, in some embodiments of the present disclosure, the bending portion 52 of the glass substrate 50 may be formed into a barb by using the difference in size between the upper die 30 and the lower die 10 of the mold 200. Thus, the manufacturing or processing mold for the glass substrate may have a simple structure and may be convenient to implement. Besides, the producing processes of the glass substrate may be simplified, and the producing efficiency of the glass substrate may be improved. When the barbed glass plate 60 is used as the housing of an electronic device, the barbed glass plate may effectively hold and retain a display module of the electronic device, and the user may have a better feel of grip.

The above may be only some embodiments of the present disclosure. It should be noted that those skilled in the art can make improvements without departing from the inventive concept of the present disclosure. All these may be covered within the protection scope of the present disclosure.

What is claimed is:

1. A mold for producing a barbed glass plate, the mold being configured for processing a glass substrate having a three-dimensional structure to form the barbed glass plate;
the barbed glass plate comprising:
a body portion;
a transition portion, bent from an edge of the body portion; and
an extension portion, bent from an edge of the transition portion; wherein the body portion, the transition portion, and the extension portion cooperatively define a receiving space opened at one end; the extension portion comprises an external surface facing away from the receiving space, and the external surface comprises:
an end point, facing away from the body portion; wherein an angle between a tangential direction of the external surface at the end point and a horizontal direction and facing away from the receiving space is set as θ, and θ satisfies: 90°<θ≤180°; and
a connection point, connected to the transition portion; wherein a tangential direction of the external surface at the connection point is substantially perpendicular to the horizontal direction;
the mold comprising:
a lower die, defining a cavity and comprising:
a bottom wall; and
a side wall, cooperating with the bottom wall to define the cavity; and
an upper die, cooperating with the lower die and comprising a protrusion;
wherein when the upper die is engaged with the lower die, the protrusion protrudes into the cavity and is spaced apart from the side wall;
wherein a first distance between the protrusion and the side wall is greater than or equal to a sum of a thickness of the extension portion and a second distance between the connection point and the end point in the horizontal direction, and is further less than or equal to twice the sum of the thickness of the extension portion and the second distance.

2. The mold according to claim 1, wherein θ satisfies: 110°≤θ≤180°.

3. The mold according to claim 1, wherein a value of the second distance is ranged from approximately 0.15 mm to approximately 1 mm.

4. The mold according to claim 1, wherein the glass substrate comprises a substrate body and a bending portion bent from the substrate body;
the side wall of the lower die comprises:
a receiving surface, configured for receiving the bending portion; and
a connecting surface, connected to the receiving surface and the bottom wall.

5. The mold according to claim 4, wherein the protrusion comprises:
a top surface, facing towards the bottom wall; and
a side surface, extending from the top surface in a direction away from the bottom wall; when the upper die is engaged with the lower die, a third distance between the side surface and the receiving surface is greater than a fourth distance between the side surface and the connecting surface; the fourth distance is greater than the sum of the thickness of the extension portion and the second distance, and less than or equal to twice the sum of the thickness of the extension portion and the second distance.

6. The mold according to claim 5, wherein the bottom wall of the lower die is flat.

7. The mold according to claim 4, wherein the receiving surface and the connecting surface are both arc.

8. The mold according to claim 4, wherein an angle between the bending portion and the substrate body is ranged from approximately 90° to approximately 100°.

9. A mold for producing a barbed glass plate, the mold being configured for processing a glass substrate having a three-dimensional structure to form the barbed glass plate;
the barbed glass plate comprising:
a body portion, comprising a first end and a second end opposite to the first end;
a first transition portion, bent from the first end of the body portion;
a second transition portion, bent from the second end of the body portion;
a first extension portion, bent from the first transition portion; and
a second extension portion, bent from the second transition portion;
wherein the body portion, the first transition portion, the second transition portion, the first extension portion, and the second extension portion cooperatively define a receiving space opened at one end;
wherein the first extension portion comprises a first external surface facing away from the receiving space, and the first external surface comprises a first end point and a first connection point; the first end point faces away from the body portion, and the first connection point is connected to the first transition portion;
wherein the second extension portion comprises a second external surface facing away from the receiving space, and the second external surface comprises a second end point and a second connection point; the second end point faces away from the body portion, and the second connection point is connected to the second transition portion;
a distance between the first end point and the second end point is less than a distance from between the first connection point and the second connection point;
the mold comprising:
a lower die, defining a cavity and comprising:
a bottom wall; and
a side wall, cooperating with the bottom wall to define the cavity; and
an upper die, cooperating with the lower die and comprising a protrusion;
wherein when the upper die is engaged with the lower die, the protrusion protrudes into the cavity and is spaced apart from the side wall;
wherein a first distance between the protrusion and the side wall is greater than or equal to a sum of a thickness of the extension portion and a second distance between the first connection point and the first end point in the horizontal direction, and is further less than or equal to twice the sum of the thickness of the extension portion and the second distance.

10. The mold according to claim 9, wherein the glass substrate comprises a substrate body and a bending portion bent from the substrate body;
the side wall of the lower die comprises:
a receiving surface, configured for receiving the bending portion; and
a connecting surface, connected to the receiving surface and the bottom wall.

11. The mold according to claim 10, wherein the protrusion comprises:
a top surface, facing towards the bottom wall; and
a side surface, extending from the top surface in a direction away from the bottom wall; when the upper die is engaged with the lower die, a third distance between the side surface and the receiving surface is greater than a fourth distance between the side surface and the connecting surface; the fourth distance is greater than the sum of the thickness of the extension portion and the second distance, and less than or equal to twice the sum of the thickness of the extension portion and the second distance.

12. A method for producing a barbed glass plate, comprising:
providing a glass substrate, the glass substrate comprising a substrate body and a bending portion bent from the substrate body;
providing a mold for producing the barbed glass plate, the mold comprising a lower die defining a cavity and an upper die cooperating with the lower die, the lower die comprising a bottom wall and a side wall, the bottom wall and the side wall cooperatively defining the cavity; the upper die comprising a protrusion;
placing the glass substrate into the cavity, wherein the bending portion abutting against the side wall, such that the substrate body is spaced apart from the bottom wall;
heating the glass substrate and the mold to a softening temperature of glass; and
engaging the upper die with the lower die, and producing the barbed glass plate with the glass substrate by means of thermal pressing;
wherein when the upper die is engaged with the lower die, the protrusion abuts against the substrate body until the substrate body is attached to the bottom wall, such that a body portion of the barbed glass plate is formed;
the bending portion is formed into a transition portion and an extension portion of the barbed glass plate by means of thermal pressing; wherein the extension portion is bent from an edge of the transition portion; the body portion, the transition portion, and the extension portion cooperatively define a receiving space opened at one end;
wherein the extension portion comprises a external surface facing away from the receiving space, and the external surface comprises:
an end point, facing away from the body portion; wherein an angle between a tangential direction of the external surface at the end point and a horizontal direction and facing away from the receiving space is set as θ, and θ satisfies: 90°<θ≤180°; and
a connection point, connected to the transition portion; wherein a tangential direction of the external surface at the connection point is substantially perpendicular to the horizontal direction; wherein a first distance between the protrusion and the side wall is greater than or equal to a sum of a thickness of the extension portion and a second distance between the connection point and the end point in the horizontal direction, and is further less than or equal to twice the sum of the thickness of the extension portion and the second distance.

13. The method according to claim 12, wherein the providing the glass substrate, comprises:
provide a planar glass;
providing a first die and a second die, wherein the first die defines a receiving cavity, and the second die comprises a protrusion that cooperates with the receiving cavity; a distance between a surface forming the receiving cavity and a surface on which the protrusion is arranged is substantially equal to a thickness of the planar glass; and
fixing the planar glass to the first die, engaging the second die with the first die, and producing the glass substrate comprising the substrate body and the bending portion by the planar glass.

14. The method according to claim 13, wherein the substrate body is flat.

15. The method according to claim 13, wherein an angle between the bending portion and the substrate body is ranged from approximately 90° to approximately 100°.

16. The method according to claim 12, wherein θ satisfies: 110°≤θ≤180°.

17. The method according to claim 12, wherein a value of the second distance is ranged from approximately 0.15 mm to approximately 1 mm.

18. The method according to claim 12, wherein the side wall of the lower die comprises:
a receiving surface, configured for receiving the bending portion; and
a connecting surface, connected to the receiving surface and the bottom wall.

19. The method according to claim 18, wherein the protrusion comprises:
a top surface, facing towards the bottom wall; and
a side surface, extending from the top surface in a direction away from the bottom wall; when the upper die is engaged with the lower die, a third distance between the side surface and the receiving surface is greater than a fourth distance between the side surface and the connecting surface; the fourth distance is greater than the sum of the thickness of the extension portion and the second distance, and less than or equal to twice the sum of the thickness of the extension portion and the second distance.

20. The method according to claim 18, wherein the receiving surface and the connecting surface are both arc.
